(19) United States
(12) Patent Application Publication
(10) Pub. No.: US 2022/0121150 A1
(43) Pub. Date: Apr. 21, 2022

(54) INSTALL TONER CARTRIDGE USING HOLDER

(71) Applicant: Hewlett-Packard Development Company, L.P., Spring, TX (US)

(72) Inventors: Mintae Kim, Suwon (KR); Junhui Kim, Pangyo (KR)

(73) Assignee: Hewlett-Packard Development Company, L.P., Spring, TX (US)

(21) Appl. No.: 17/414,130

(22) PCT Filed: Dec. 20, 2019
(86) PCT No.: PCT/US2019/067917

§ 371 Date: Jun. 15, 2021

(30) Foreign Application Priority Data
Jul. 5, 2019 (KR) 10-2019-0081607

(51) Int. Cl. G03G 21/16

(52) U.S. Cl. CPC G03G 21/1676; G03G 2221/1869; G03G 2221/1684; G03G 21/1633

(57) ABSTRACT

An example image forming apparatus includes a main body including a cover, a location determining member coupled to the main body to settle a toner cartridge in an image forming location, a sliding member slidably coupled to the main body to move the toner cartridge between a first location outside the main body and a second location inside the main body, and a holder connected with the cover to move the toner cartridge located in the second location to a third location contacting the location determining member according to a movement of the cover.

### BACKGROUND

An image forming apparatus is an apparatus that develops a black and white image or a color image on a printing medium such as paper according to an image signal. Examples of an image forming apparatus include printers, copiers, scanners, facsimiles, multi-function printers (MFP), etc.

An image forming apparatus may use a replaceable toner cartridge. In such an image forming apparatus, a sliding member on which a plurality of toner cartridges are separately mounted may be provided on the inner side of the main body, for replacing the toner cartridge.

### BRIEF DESCRIPTION OF THE DRAWINGS

FIG. 1 is a perspective view illustrating an image forming apparatus according to an example;

FIG. 2A is a front view illustrating a state wherein a toner cartridge of an image forming apparatus is arranged in a first location outside a main body according to an example;

FIG. 2B is a front view illustrating a state wherein a toner cartridge of an image forming apparatus is arranged in a second location inside a main body according to an example;

FIG. 2C is a front view illustrating a state wherein a toner cartridge of an image forming apparatus is arranged in a third location inside a main body according to an example;

FIG. 3 is a perspective view of a sliding member according to an example;

FIG. 4 is a perspective view of a connecting member according to an example;

FIG. 5A is a perspective view of a holder according to an example;

FIG. 5B is an enlarged view illustrating the A area in FIG. 2C according to an example;

FIG. 6 is a diagram illustrating the sliding member, the holder, the connecting member, and the location determining member in the states as illustrated in FIG. 2A according to an example;

FIG. 7A is a diagram illustrating the sliding member, the holder, the connecting member, and the location determining member in the states as illustrated in FIG. 2B according to an example;

FIG. 7B is a schematic diagram illustrating the locations of the toner cartridge and the location determining member as illustrated in FIG. 7A according to an example;

FIG. 8A is a diagram illustrating the sliding member, the holder, the connecting member, and the location determining member in the states as illustrated in FIG. 2C according to an example;

FIG. 8B is a schematic diagram illustrating the locations of the toner cartridge and the location determining member as illustrated in FIG. 7A according to an example;

FIG. 9A is a schematic diagram illustrating an interlocked structure of a handle of a sliding member and a locking member in case the sliding member is arranged in a first location according to an example; and

FIG. 9B is a schematic diagram illustrating an interlocked structure of a handle of a sliding member and a locking member in case the sliding member is arranged in a second location according to an example.

### DETAILED DESCRIPTION OF EXAMPLES

Hereinafter, various examples of the disclosure will be described with reference to the accompanying drawings. The examples described below may be implemented while being modified into several different forms. Also, with respect to matters that are widely known to those of ordinary skill in the art to which the following examples belong, detailed explanation will be omitted, for explaining the characteristics of the examples more clearly.

In the following description, an element that is described as “connected to” another element may be interpreted to include both the case in which the element is directly connected to the other element, and the case in which the element is connected to the other element through still another element. Also, an element that is described to “include” another element can be interpreted to mean that other elements may additionally be included, but not that other elements are excluded, unless there is a description to the contrary.

The term “image forming job” may refer to various jobs (e.g., printing, copying, scanning, or faxing) related to an image, such as forming the image or generating/storing/transmitting an image file, and the term “job” may refer to the image forming job in some examples, and may also refer to a series of processes necessary for performing the image forming job in other examples.

The term “image forming apparatus” may refer to an apparatus that prints print data generated by a terminal apparatus such as a computer on a recording paper. Examples of such an image forming apparatus include a copier, a printer, a scanner, a facsimile, or a multi-function printer (MFP) that combines functions thereof through a single apparatus.

The term “hard copy” may refer to an operation of outputting an image on a printing medium such as paper, etc., and the term “soft copy” may refer to an operation of outputting an image on a display apparatus like a television (TV), a monitor, etc. or outputting the image to a storage (e.g., memory)

The term “printing data” may refer to data converted into a printable format on a printer. Meanwhile, if a printer supports direct printing, a file itself may become printing data.

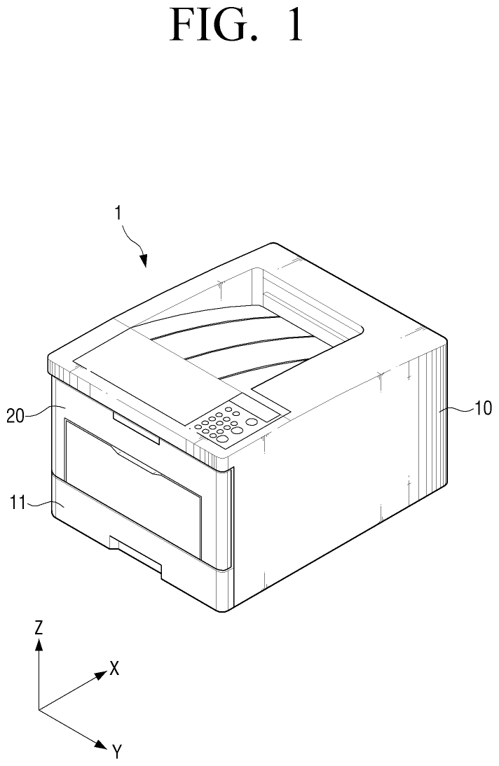

FIG. 1 is a perspective view illustrating an image forming apparatus according to an example.

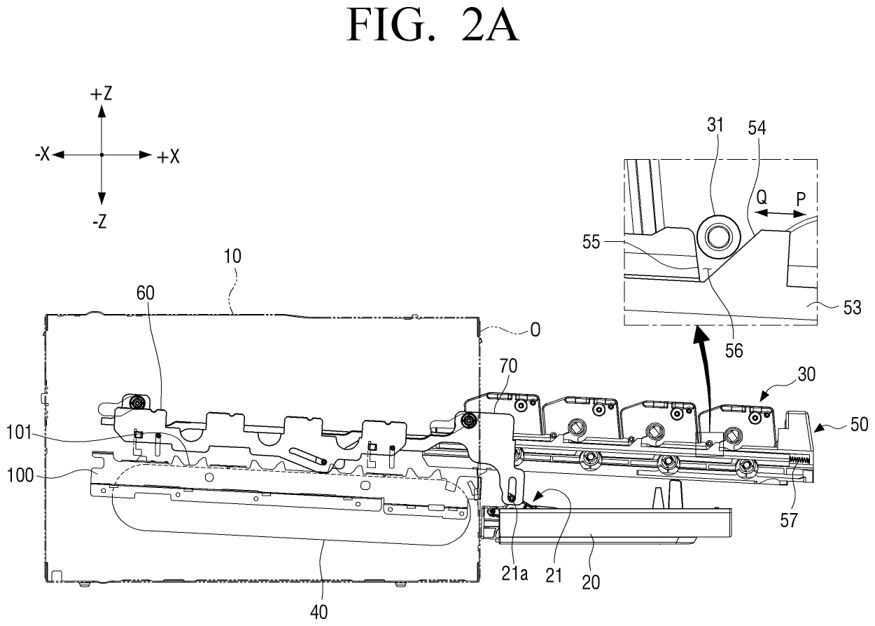

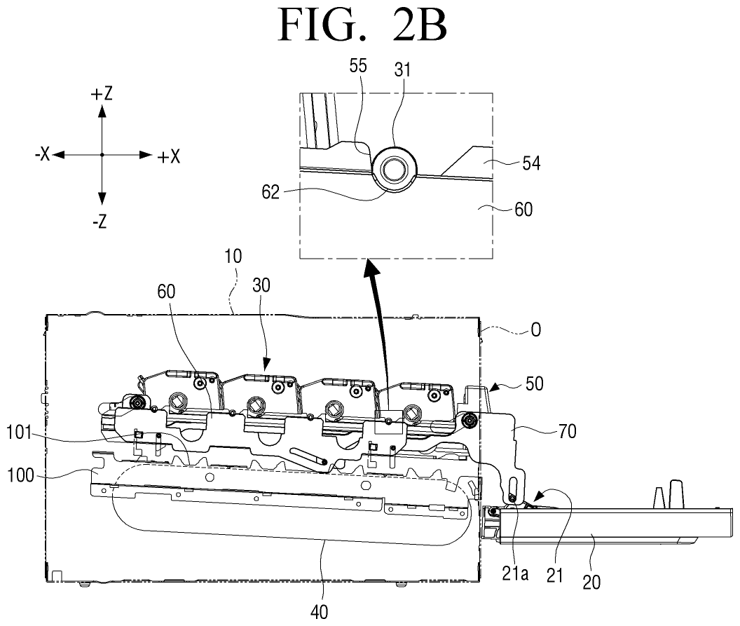

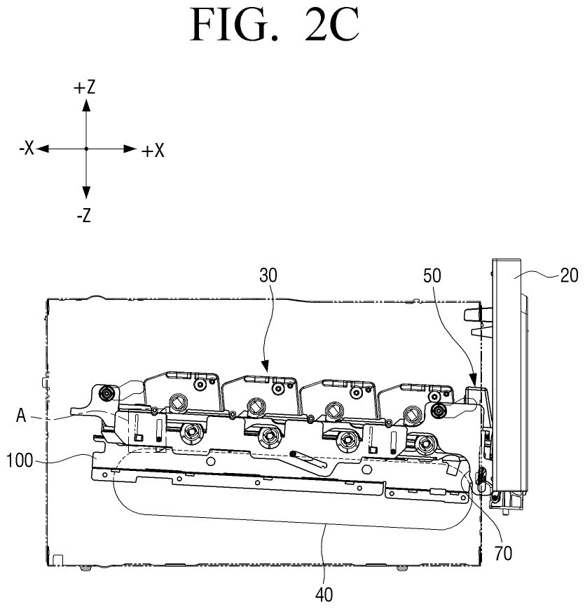

Referring to FIG. 1, an image forming apparatus 1 may form an image of printing data provided from an external apparatus (not shown) on a recording medium (hereinafter, referred to as ‘paper’) (not shown) by using a main body 10, and a toner cartridge 30 (refer to FIG. 2A) that is separably arranged inside the main body 10. The image forming apparatus 1 may include a tray or drawer 11 removably coupled to the main body 10 to receive the recording medium.

The main body 10 may include a cover 20 for opening and closing (i.e., exposing and covering) an opening O (refer to FIG. 2A) from which a sliding member 50 (refer to FIG. 2A) may be drawn-in or drawn-out (i.e., removed or inserted).

In an example, drawing-in and drawing-out of the sliding member 50 (refer to FIG. 2A) may be interlocked with opening and closing of the cover 20 such that the toner cartridge 30 may be stably installed in the main body 10.

In an example, operations that correspond to opening and closing of the cover 20 may be divided into operations by which the toner cartridge 30 is drawn into and drawn out from the inside of the main body 10, and operations by which a photosensitive drum provided on the toner cartridge 30 contacts and is spaced apart from a transfer unit (e.g., an intermediate transfer belt).

Hereinafter, example operations by which the toner cartridge 30 is drawn into and drawn out from the inside of the main body 10 will be described.

FIG. 2A is a front view illustrating a state wherein a toner cartridge of an image forming apparatus is arranged in a first location outside a main body according to an example. FIG. 2B is a front view illustrating a state wherein a toner cartridge of an image forming apparatus is arranged in a second location inside a main body according to an example. FIG. 2C is a front view illustrating a state wherein a toner cartridge of an image forming apparatus is arranged in a third location inside a main body according to an example.

An example will be described based on the assumption that the image forming apparatus 1 includes a plurality of toner cartridges 30. However, in other examples, the image forming apparatus 1 may include only one toner cartridge 30.

Referring to FIG. 2A, the plurality of toner cartridges 30 may be located in a first location that is outside the main body 10. In this case, the plurality of toner cartridges 30 may be located outside the main body 10 in a state of being supported by the sliding member 50.

Here, the sliding member 50 may be in a state wherein a portion thereof is within the main body 10. In the first location, a projecting part 31 of the toner cartridge 30 is settled in a first settling groove 56.

The sliding member 50 may be slidably arranged with respect to the main body 10, and may move the installed toner cartridge between a first location that is outside the main body 10 and a second location that is inside the main body 10.

In an example, each of the plurality of toner cartridges 30 may be separably settled in the sliding member 50, and the sliding member 50 may be slidably arranged with respect to the main body 10 so as to be drawn inside the main body 10 or drawn outside the main body 10.

Each of the plurality of toner cartridges 30 may include a toner bottle (not shown) and a developing roller (not shown). Here, a toner bottle refers to a bottle containing toner (or developing agents), and the toner bottle of each of the plurality of toner cartridges 30 may have toner of a different color (e.g., cyan (C), magenta (M), yellow (Y), and black (K)). Also, a developing roller refers to a component that provides toner from a toner cartridge to a photosensitive drum.

Referring to FIG. 2B, the plurality of toner cartridges 30 may move inside the main body 10 in a state of being supported by the sliding member 50 and may be located in the second location. That is, the plurality of toner cartridges 30 may be supported by the sliding member 50 when moving from the first location to the second location and may move in a parallel direction from the outside of the main body 10 to the inside of the main body 10.

In the second location, the projecting part 31 of the toner cartridge 30 is settled in a second settling groove 62.

Hereinafter, example operations by which a photosensitive drum provided on the toner cartridge 30 may contact and be spaced apart from a transfer unit (e.g., an intermediate transfer belt) will be described.

The image forming apparatus 1 may include a holder 60 to move the plurality of toner cartridges 30 located in the second location to a third location contacting a location determining member 100 according to opening and closing operations of the cover 20.

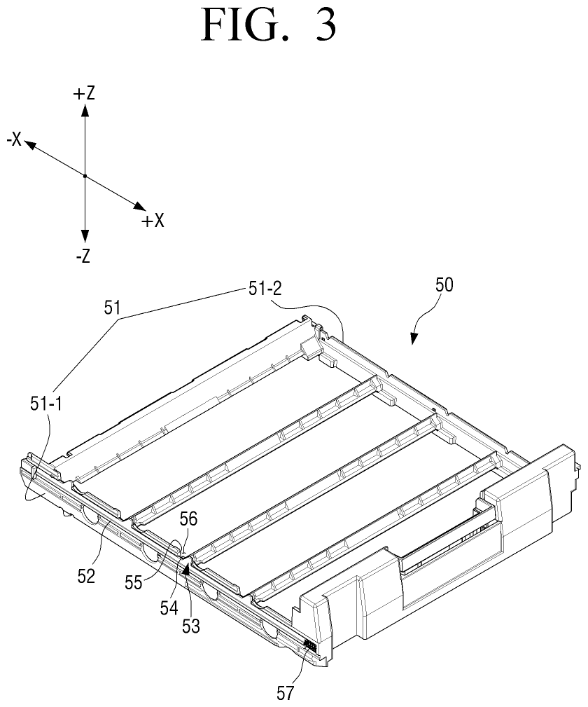

In an example, in a state wherein the sliding member 50 was drawn inside the main body 10 and the cover 20 was closed, by the operation of the holder 60, the plurality of toner cartridges 30 may move to a third location at which photosensitive drums of the toner cartridges 30 contact an intermediate transfer belt 40 as in FIG. 2C. That is, the plurality of toner cartridges 30 may be supported by the holder 60 when moving from the second location to a third location and may move in a vertical direction inside the main body 10. An example of components and an operation of the holder 60 will be described later with reference to FIG. 3.

As described above, movements of the plurality of toner cartridges 30 installed on the image forming apparatus 1 may be performed independently in each location by the sliding member 50 and the holder 60. Accordingly, the plurality of toner cartridges 30 may be stably installed in the main body 10.

Hereinafter, an example of components for movements of the toner cartridges 30 as described above will be explained.

A lower end of the cover 20 may be hinge-coupled to the main body 10. When the sliding member 50 is drawn out, an upper end of the cover 20 may be pulled to the direction of the outside of the main body 10 as in FIG. 2A, and the opening O of the main body 10 may be opened.

Also, the cover 20 may be coupled to a connecting member 70 by a cover lever 21. An upper end portion of the cover lever 21 may be hinge-coupled to the cover 20, and a lower end portion 21a of the cover lever 21 may be coupled to an elongated hole 72 of the connecting member 70 so as to be slidably movable.

Accordingly, when the cover 20 is opened, the cover lever 21 may rotate (e.g., in a clockwise direction) with its lower end portion 21a at the center of the elongated hole 72 and pull the connecting member 70 in a +X direction. When the cover 20 is closed, the cover lever 21 may rotate in a counterclockwise direction with its lower end portion 21a at the center of the elongated hole 72 and push the connecting member 70 in a −X direction, and thereby move a guide rail 52 of the sliding member 50 along an X direction.

The connecting member 70 may be cam-coupled with the holder 60. Also, a guide projection 71 formed on the connecting member 70 may be inserted into a guide groove 61 of the holder 60 and may be cam-coupled. In addition, the guide projection 71 may be arranged to be slidably movable along the guide groove 61.

Here, the connecting member 70 may also be referred to as a guide tray.

The holder 60 may move in a +Z direction when the connecting member 70 moves in a +X direction and may move in a −Z direction when the connecting member 70 moves in a −X direction.

The holder 60 may be connected to the cover 20 through the connecting member 70. Accordingly, when the cover 20 is opened, the connecting member 70 may move in a drawing-out direction (i.e., the +X direction). Here, the holder 60 may move in the +Z direction by the guide projection 71 that is cam-coupled to the guide groove 61.

In contrast, when the cover 20 is closed, the connecting member 70 may move in a drawing-in direction (i.e., the −X direction). Here, the holder 60 may move in the −Z direction by the guide projection 71 that is cam-coupled to the guide groove 61.

An example of a connection structure between the connecting member 70 and the holder 60 will be described later.

On the inside of the main body 10 of the image forming apparatus 1, the intermediate transfer belt 40 may be arranged on the lower side of the sliding member 50. Also, the plurality of toner cartridges 30 may be supported by the holder 60 and move toward the intermediate transfer belt 40.

The location determining member 100, on which a plurality of location determining grooves 101 may be formed, may be arranged on the upper side of the intermediate transfer belt 40. The location determining member 100 may adjust the location of each of the plurality of toner cartridges 30 such that the plurality of toner cartridges 30 are settled in image forming locations.

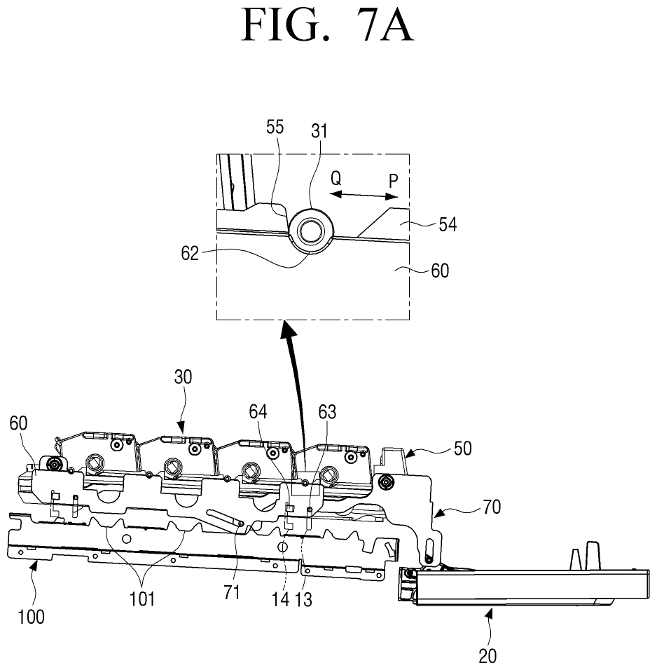

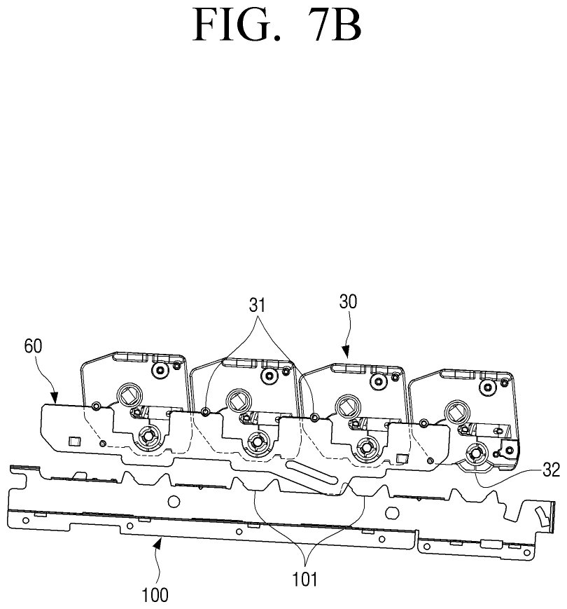

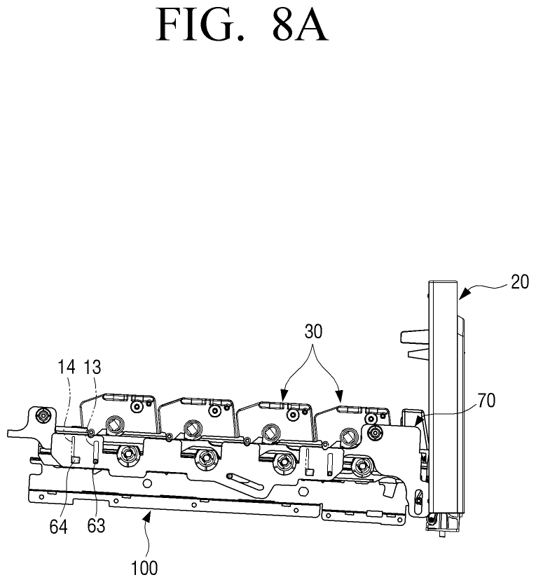

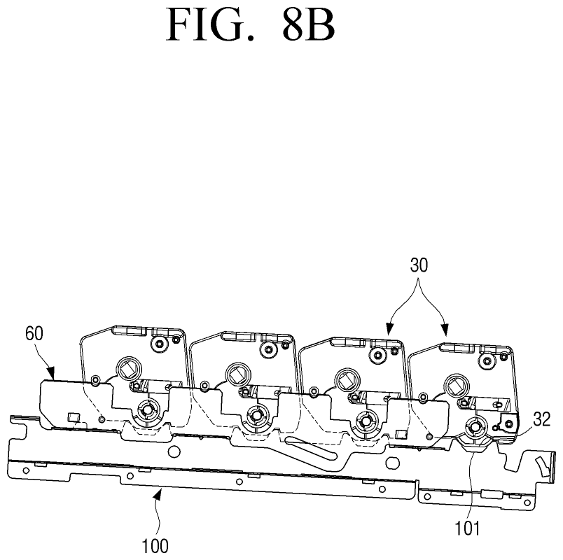

In an example illustrated in FIGS. 7B and 8B, a location determining projection 32 formed on one surface of each of the plurality of toner cartridges 30 may be respectively inserted into the plurality of location determining grooves 101 of the location determining member 100 when the plurality of toner cartridges 30 is located in the third location.

The locations of each of the toner cartridges 30 may be adjusted to image forming locations by the location determining member 100. The location determining member 100 may include the location determining projection 32 supporting portions of the lower sides of the plurality of toner cartridges 30.

The location determining projection 32 may be arranged in a location corresponding to an image forming location, and the plurality of toner cartridges 30 supported by the location determining projection 32 may be located in image forming locations.

In addition, each toner cartridge 30 may include the projecting part 31 of the toner cartridge 30 that is formed to project from its side surface to the outside the toner cartridge 30. The projecting part 31 may be moved from the first settling groove 56 formed on the sliding member 50 to the second settling groove 62 formed on the holder 60 in the second location.

The toner cartridge 30 may be supported by the first settling groove 56 of the sliding member 50 or the second settling groove 62 of the holder 60 by the projecting part 31 formed on each of both side surfaces of the toner cartridge 30.

The photosensitive drum of each toner cartridge 30 settled on the location determining member 100 may contact the surface of the intermediate transfer belt 40. The intermediate transfer belt 40 may rotate in an opposite direction to the photosensitive drum, receive a visible image transferred from the photosensitive drum, and transfer the received visible image to a printing medium.

The holder 60 may move the toner cartridge 30 in a vertical direction from the second location to the third location such that the toner cartridge 30 can be settled on the location determining member 100. Accordingly, the toner cartridge 30 settled on the location determining member 100 may be located in an image forming location by the location determining member 100.

FIG. 3 is a perspective view of a sliding member according to an example.

Referring to FIG. 3, the sliding member 50 may include a first frame 51 which includes a first supporting surface 55 that moves in a first direction (i.e., a −X direction) wherein the sliding member 50 faces the second location from the first location, and forms one surface of the first settling groove 56.

The first frame 51 may include a first side portion frame 51-1 and a second side portion frame 51-2 that form the overall exterior of the sliding member 50, and are slidably coupled to the inside of the main body 10 along an X direction.

The first side portion frame 51-1 and the second side portion frame 51-2 may be coupled to a second frame 53 which is arranged to be movable in a drawing-in direction and a drawing-out direction of the sliding member 50.

The sliding member 50 may include the second frame 53 that includes a second supporting surface 54 that selectively spaces the projecting part 31 of the toner cartridge 30 apart from the second settling groove 62 and is slidably provided on the side surface of the sliding member 50.

The second frame 53 may include a second supporting surface 54 that moves in a second direction (i.e., a +X direction) which is opposite to the first direction (i.e., the −X direction) with respect to the first frame 51, and forms the other surface of the first settling groove 56.

The second frame 53 may move in an X direction while being interlocked with drawing-in and drawing-out operations of the sliding member 50. In an example, when the sliding member 50 moves in the drawing-in direction (i.e., the −X direction), the second frame 53 may move in the +X direction which is an opposite direction, and when the sliding member 50 moves in the drawing-out direction (i.e., the +X direction), the second frame 53 may move in the −X direction which is an opposite direction.

The second frame 53 may include a plurality of second supporting surfaces 54 that project upwards from the second frame 53. The plurality of second supporting surfaces 54 may be arranged at predetermined intervals.

One side surface of the second supporting surface 54 may be tilted. The first settling groove 56 that may support the toner cartridge 30 may be formed from the one side surface of the second supporting surface 54 that is tilted and the first supporting surface 55 formed on the side surface of the sliding member 50.

The second supporting surface 54 may move between a supporting location (refer to FIG. 2A) that can support the toner cartridge 30 and a support release location (refer to FIG. 2C) that does not support the toner cartridge 30 according to movement of the second frame 53.

The sliding member 50 may include a pressing member 57 having one end supported by a surface of the sliding member 50, and the other end supported by the second frame 53. The pressing member 57 may pressure-support the second frame 53 in the drawing-in direction (i.e., the −X direction). In addition, the pressing member 57 may be provided to slide-move the second frame 53 in a second direction (i.e., a Q direction). In an example, the sliding member 50 may include a spring to provide an elastic force to the second frame 53.

In an example, the pressing member 57 may be arranged between one end of the second frame 53 and the first frame 51 to pressurize the second frame 53 in the first direction (i.e., the −X direction).

An example of a shape and an operation of the second frame 53 will be described later.

On the outer side surface of the second frame 53, the guide rail 52 to couple with the connecting member 70 may be formed. The guide rail 52 may be extensively formed along the drawing-in direction and the drawing-out direction of the sliding member 50. The connecting member 70 may be coupled with the guide rail 52 and move the sliding member 50 in an X direction.

The connecting member 70 may be provided to connect the cover 20 and the holder 60.

For example, when the cover 20 is opened, the connecting member 70 may move in the +X direction, and while moving in the +X direction, pull the sliding member 50 in the +X direction. When the cover 20 is closed, the connecting member 70 may move in the −X direction, and while moving in the −X direction, push the sliding member 50 in the −X direction. Also, the connecting member 70 may move the guide rail 52 along the X direction.

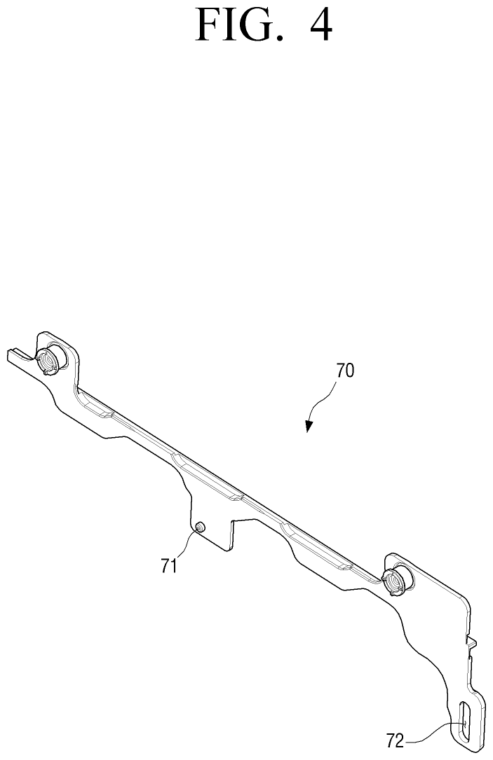

Hereinafter, an example operation of moving the holder 60 in a vertical direction while being interlocked with opening and closing of the cover 20 in the image forming apparatus 1 will be explained with reference to FIGS. 4 to 8B.

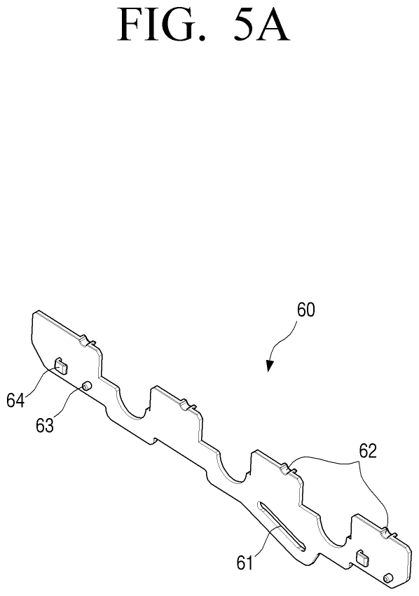

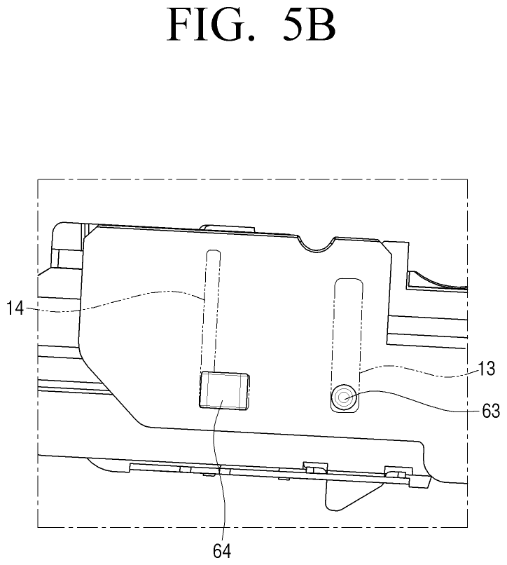

First, an example configuration of the holder 60 and the connecting member 70 will be explained with reference to FIGS. 4, 5A, and 5B.

FIG. 4 is a perspective view of a connecting member according to an example. FIG. 5A is a perspective view of a holder according to an example. FIG. 5B is an enlarged view illustrating the A area in FIG. 2C according to an example.

Referring to FIGS. 4, 5A, and 5B, on one side of the connecting member 70, the elongated hole 72 for connection to the cover lever 21 may be formed, and the guide projection 71 may be formed. In an example, a plurality of guide projections may be formed at predetermined intervals.

The connecting member 70 may be connected to the cover 20 by the cover lever 21 coupled to the elongated hole 72 and may move in the X direction while being interlocked with opening and closing operations of the cover 20.

The guide projection 71 may project on the lower end of the connecting member 70 and may be inserted in the guide groove 61 formed on the holder 60 that will be described below. In an example in which a plurality of guide projections 71 are included, each of the plurality of guide projections 71 may be insertively arranged in the guide groove 61.

The connecting member 70 may cam-contact with the holder 60 by the guide projection 71 and the guide groove 61.

The holder 60 may move up and down by the movement of the cover 20. For example, the holder 60 may ascend (i.e., the +Z direction) if the cover 20 is opened and descend (i.e., the −Z direction) if the cover 20 is closed.

The holder 60 may move the toner cartridge 30 from the second location coupled with the holder 60 to the third location coupled with the location determining member 100.

On the holder 60, a guide groove 61 that guides the guide projection 71 (i.e., cam-contacts) may be formed. The guide groove 61 may tilt at a predetermined angle on the holder 60. The tilting direction of the guide grooves 61 may be directed toward the drawing-out direction (i.e., the X direction) of the sliding member 50 from the upper end to the lower end. In an example, a plurality of guide grooves 61 may be provided wherein the guide projection 71 cam-contacts the plurality of guide grooves 61.

The holder 60 may be arranged to be movable in a Z direction inside the main body 10 and may move in a direction perpendicular to the drawing-in and drawing-out directions (i.e., the X direction) of the sliding member 50 inside the main body 10.

By the cam-contact of the guide projection 71 and the guide groove 61, the holder 60 may receive a force from the guide projection 71 moving in the X direction and move in the Z direction.

The holder 60 may include a plurality of cam rings 64 and cam projections 63 so as to move in a vertical direction.

The plurality of cam rings 64 and the plurality of cam projections 63 may be formed at predetermined intervals. Each of the cam rings 64 and the cam projections 63 may be respectively inserted in a cam hanging part 14 and a cam groove 13 formed on the frame of the main body 10.

The cam hanging part 14 and the cam groove 13 may extend along a vertical direction (i.e., the Z direction) on the frame of the main body 10 such that the holder 60 can move in a vertical direction.

The cam rings 64 coupled with the cam hanging part 14 may move in the Z direction along the cam hanging part 14, and the cam projections 63 coupled with the cam groove 13 may move in the Z direction along the cam groove 13.

The holder 60 may be connected to the cover 20, and may move the toner cartridge 30 located in the second location to the third location contacting the location determining member 100, according to opening and closing operations of the cover 20.

The holder 60 may receive the toner cartridge 30 arranged in the second location from the sliding member 50. On the upper side of the holder 60, a plurality of second settling grooves 62 formed at predetermined intervals may be included. The holder 60 may support a plurality of toner cartridges 30 of which one end is respectively inserted into the plurality of second settling grooves 62.

That is, the holder 60 may include the plurality of second settling grooves 62 into which the projecting part 31 formed on the side surface of the plurality of toner cartridges 30 is respectively inserted.

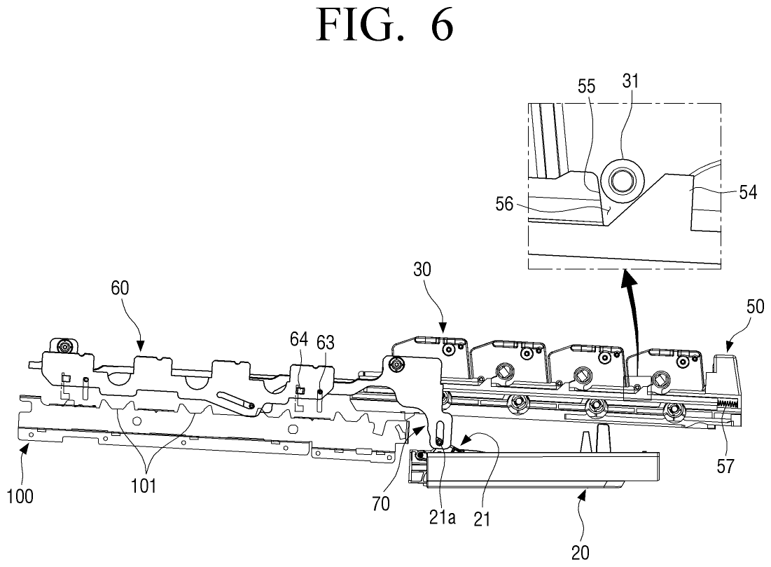

Hereinafter, an example of movements of the holder 60 will be explained with reference to FIGS. 6 to 8B.

FIG. 6 is a diagram illustrating the sliding member, the holder, the connecting member, and the location determining member in the states as illustrated in FIG. 2A according to an example. FIG. 7A is a diagram illustrating the sliding member, the holder, the connecting member, and the location determining member in the states as illustrated in FIG. 2B according to an example. FIG. 7B is a schematic diagram illustrating the locations of the toner cartridge and the location determining member as illustrated in FIG. 7A according to an example. FIG. 8A is a diagram illustrating the sliding member, the holder, the connecting member, and the location determining member in the states as illustrated in FIG. 2C according to an example. FIG. 8B is a schematic diagram illustrating the locations of the toner cartridge and the location determining member as illustrated in FIG. 7A according to an example.

Referring to FIGS. 6 to 8B, the holder 60, cam-coupled with the connecting member 70, may move along the Z direction as the connecting member 70 moves along the X direction.

Referring to FIGS. 2A and 6, the holder 60 may be connected to the cover 20 through the connecting member 70.

If the cover 20 is opened, the connecting member 70 may move in the drawing-out direction (i.e., the +X direction), and move toward the lower end portion of the guide groove 61 as the guide projection 71 moves in the +X direction.

As an example, the holder 60 may receive a moving force in a horizontal direction by the guide projection 71 that moves in the +X direction toward the lower end portion of the guide groove 61. The moving force is converted to a vertical direction of the main body 10 by the cam rings 64 and the cam projections 63, and thus the holder 60 may move in the +Z direction.

Here, the cover 20 is in a fully opened state. Thus, the guide projection 71 may be arranged at one end of the guide groove 61, and the cam rings 64 and the cam projections 63 may be respectively arranged at one end of the cam hanging part 14 and the cam groove 13.

In the first location, the toner cartridge 30 may be supported by the sliding member 50. In an example, the toner cartridge 30 may be supported by the first settling groove 56 formed between the second supporting surface 54 of the second frame 53 and the first supporting surface 55 of the sliding member 50.

The second supporting surface 54 may move in a horizontal direction while being interlocked with the movement of the sliding member 50 in a horizontal direction, and form the first settling groove 56.

In an example, if the sliding member 50 moves in the drawing-out direction (i.e., the +X direction), the second supporting surface 54 may move in the −X direction and move to a supporting location adjacent to the first supporting surface 55. In this case, the toner cartridge 30 may be supported by the first settling groove 56 formed between the second supporting surface 54 and the first supporting surface 55.

In the first location, the toner cartridge 30 may be supported by the sliding member 50 by the first settling groove 56. In addition, in the first location, the toner cartridge 30 may be supported by the sliding member 50 and move together with the sliding member 50.

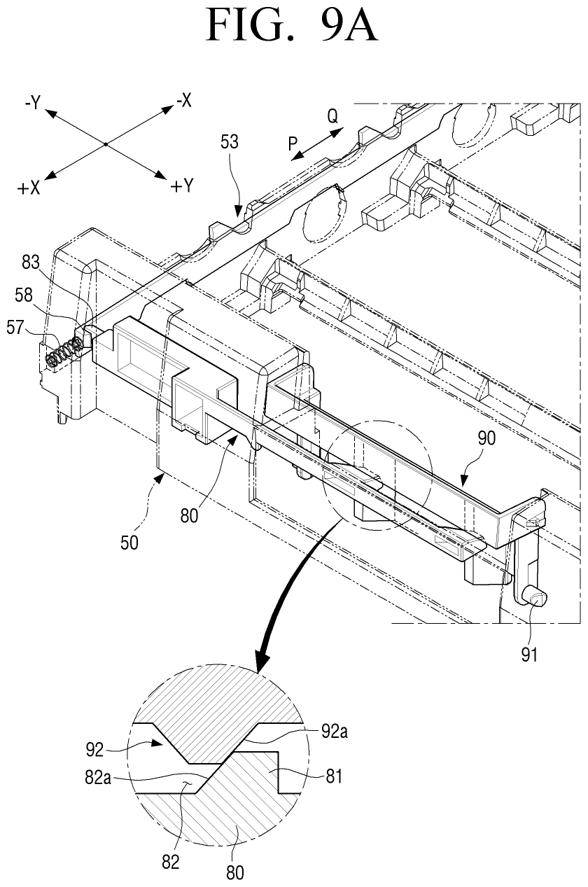

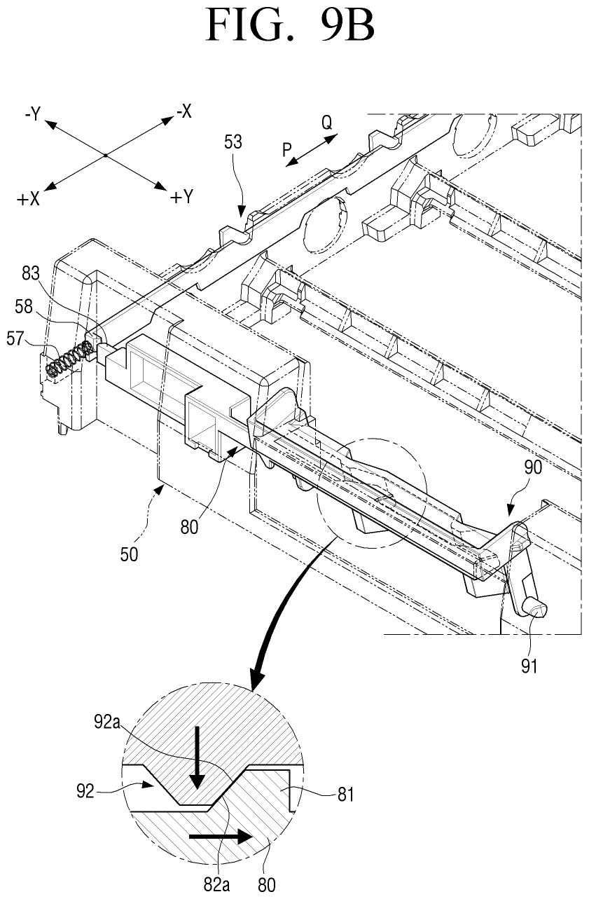

In an example, in the first location in FIG. 6, the second frame 53 may be pressurized in the second direction (i.e., the Q direction) by the pressing member 57 (refer to FIG. 9A). Accordingly, the second supporting surface 54 of the second frame 53 may move to the upper part of the second settling groove 62 of the holder 60, and prevent the projecting part 31 of the toner cartridge 30 from being inserted into the second settling groove 62.

That is, in the first location, the second supporting surface 54 may be arranged in the upper part of the second settling groove 62, and cause the projecting part 31 of the toner cartridge 30 to be spaced apart from the second settling groove 62, and at the same time, support the projecting part 31 of the toner cartridge 30.

Referring to FIGS. 2B and 7A, the sliding member 50 including the toner cartridge 30 may move from the first location, at which the sliding member 50 is not inserted into the inside of the main body 10, to the second location, at which the sliding member 50 is inserted into the inside of the main body 10.

Here, the sliding member 50, including the toner cartridge 30, may have been installed inside the main body 10, and by the movement of the connecting member 70, the sliding member 50 may move in a horizontal direction along the guide rail 52 formed in a horizontal direction (i.e., an X-axis direction).

As the sliding member 50 moves horizontally in the −X direction along the guide rail 52, the second frame 53 may be pressurized by a pressing projection (not shown) formed inside the frame on the other end of the second frame 53 which is opposite to the end on which the pressing member 57 is arranged.

Accordingly, the second frame 53 and the second supporting surface 54 of the second frame 53 may partially move in the second direction (i.e., the P direction), and the second supporting surface 54 may partially move in the second direction (i.e., the P direction) from the location at which the second settling groove 62 of the holder 60 is formed.

In an example, if the sliding member 50 moves in the drawing-in direction (i.e., the −X direction), the second supporting surface 54 may move in the +X direction and move to a support release location spaced apart from the first supporting surface 55.

Accordingly, the first supporting surface 55 and the second supporting surface 54 are separated and the first settling groove 56 is released, and thus the projecting part 31 of the toner cartridge 30 may be inserted into the second settling groove 62.

That is, the toner cartridge 30 may move to the holder 60 as support by the sliding member 50 is released.

That is, in the second location, the plurality of toner cartridges 30 may be supported by the second settling groove 62 of the holder 60 as support by the sliding member 50 is released.

In an example, considering that the holder 60 is a component that moves as the connecting member 70 moves according to the movement of the cover 20, as the cover 20 is still open in the second location, the holder 60 may not have moved.

That is, in the second location, as the sliding member 50 is inserted inside the main body 10, the toner cartridge 30 may be supported by the holder 60.

The settling location of the projecting part 31 in the second settling groove 62 may be the same as or lower than the settling location in the first settling groove 56.

Referring to FIGS. 2C and 8A, as the connecting member 70 moves as the cover 20 is closed, the holder 60 connected through the guide projection 71 of the connecting member 70 may move in the lower side direction (i.e., the −Z direction).

Here, the holder 60 may move as it receives a moving force from the guide projection 71 through the guide groove 61 into which the guide projection 71 is inserted and moves.

The holder 60 may move in a vertical direction (i.e., the Z-axis direction) as the cam rings 64 and the cam projections 63, formed on one side surface of the holder 60 and respectively inserted into the cam hanging part 14 and the cam groove 13 formed in a vertical direction of the main body 10, move.

In contrast, if the cover 20 is completely closed, the connecting member 70 moves in the drawing-in direction (i.e., the −X direction) and the guide projection 71 moves in the −X direction, and accordingly, the holder 60 may move in the −Z direction.

Here, the holder 60 may receive a moving force in a horizontal direction by the guide projection 71 moving in the −X direction toward the upper end portion of the guide groove 61, and the moving force is converted to a vertical direction of the main body 10 by the cam rings 64 and the cam projections 63, and thus the holder 60 may move in the −Z direction.

Accordingly, as the cover 20 is completely closed, the guide projection 71 may be arranged at an end of the guide groove 61, and the cam rings 64 and the cam projections 63 may be respectively arranged at ends of the cam hanging part 14 and the cam groove 13.

Accordingly, when the sliding member 50 moves from the first location at which the cover 20 is opened to the second location, the sliding member 50 may move in a horizontal direction along the guide rail 52.

Also, referring to FIGS. 7B and 8B, as the state of the cover 20 is changed from an opened state to a closed state, the moving distance of the holder 60 supporting the toner cartridge 30 may be longer than the moving distance of the toner cartridge 30.

In addition, the holder 60 may be located in a fourth location adjacent to the sliding member 50 if the cover 20 is opened, and if the cover 20 is closed, the holder 60 may move to a fifth location at which the toner cartridge 30 installed to be adjacent to the location determining member 100 is located in an image forming location of the location determining member 100.

That is, according to opening and closing operations of the cover 20, the holder 60 may move from the state of the fourth location adjacent to the sliding member 50 and supporting the toner cartridge 30 to the state of the fifth location at which the toner cartridge 30 is supported by the location determining member 100.

For example, in the second location at which the projecting part 31 of the toner cartridge 30 is inserted into the second settling groove 62 of the holder 60, the holder 60 may move lower in a vertical direction as the cover 20 is closed.

Afterwards, the location determining projection 32 of the toner cartridge 30 is supported by a location determining groove 101 of the location determining member 100, and the holder 60 may continuously move in a state of being separated from the toner cartridge 30.

Accordingly, the toner cartridge 30 may not be limited to being in an image forming state which is the third location only by the movement of the holder 60, but may form an image forming state by being supported by the location determining member 100.

That is, as an image forming state is not formed by the holder 60 which is a moving component, but is formed by the location determining member 100 fixed to the main body 10, the image forming apparatus 1 may form a stable image forming state.

In addition, when the sliding member 50 moves from the second location to the third location at which the cover 20 is completely closed, the sliding member 50 may be inserted into the holder 60 and move in a vertical direction.

Accordingly, as the sliding member 50 moves in a vertical direction or in a horizontal direction, a phenomenon in which the sliding member 50 contacts components inside the main body 10 more than necessary can be avoided.

Accordingly, stable movement of the sliding member 50 can be implemented, and at the same time, friction between the toner cartridge 30 and the other components can be minimized. Thus, durability of the toner cartridge 30 can be improved and stable contact between the toner cartridge 30 and the intermediate transfer belt 40 can be implemented.

In a case in which the plurality of toner cartridges 30 move from the third location to the first location, if the sliding member 50 moves in the drawing-out direction (i.e., the +X direction), the second supporting surface 54 may move in the −X direction and form the first settling groove 56 with the first supporting surface 55 as in FIG. 6. Also, the toner cartridges 30 may move from the holder 60 to the sliding member 50, and move in a horizontal direction (i.e., the X direction) together with the sliding member 50.

Hereinafter, an interlocked structure of a handle 90 of the sliding member 50 and a locking member 80 will be explained with reference to FIGS. 9A and 9B.

FIG. 9A is a schematic diagram illustrating an interlocked structure of a handle of a sliding member and an locking member in case the sliding member is arranged in a first location according to an example. FIG. 9B is a schematic diagram illustrating an interlocked structure of a handle of a sliding member and a locking member in case the sliding member is arranged in a second location according to an example.

Referring to FIGS. 9A and 9B, the sliding member 50 may include the locking member 80 which is arranged between the handle 90 and the second frame 53. The locking member 80 fixes the second frame 53 to release the first settling groove 56, and is spaced apart from the second frame 53 to form the first settling groove 56.

The locking member 80 may be selectively engaged with a supporting block 58 according to the movement of the handle 90 of the sliding member 50.

On the upper side of the sliding member 50, the handle 90 may be rotatively arranged. On the inner side of the sliding member 50, the locking member 80 may be arranged to be slidably movable along the width direction of the sliding member 50.

For example, the locking member 80 may slide along the width direction of the sliding member 50 while being interlocked with the rotation of the handle 90 in a clockwise direction and a counterclockwise direction.

On both sides of the handle 90, hinge projections 91 that are hingeably coupled to the sliding member 50 may be respectively formed. Accordingly, the handle 90 may rotate at predetermined angles in the drawing-in direction and the drawing-out direction of the sliding member. On the inside of the handle 90, a contact projection 92 may be formed. The contact projection 92 may have a tilted cam surface 92a.

On the locking member 80, a contact projection 81 may form a recess 82 to which the contact projection 92 of the handle 90 is coupled. The contact projection 81 may include a sliding surface 82a that slidably contacts the cam surface 92a of the contact projection 92.

If the handle 90 is rotated in the drawing-out direction (i.e., the +X direction) of the sliding member 50, the locking member 80 may move in the direction of the handle 90, and the pressing member 57 supporting the second frame 53 in the drawing-in direction (i.e., the −X direction) may push the second frame 53 in the drawing-in direction (i.e., the −X direction).

If the handle 90 is rotated in the drawing-in direction (i.e., the −X direction) of the sliding member 50, the locking member 80 may move in the opposite direction of the handle 90 and restrict the pressurizing force of the pressing member 57 supporting the second frame 53, and the second frame 53 may move in the drawing-out direction (i.e., the +X direction).

The second frame 53 may be elastically supported by the pressing member 57 that supports pressurizing the second frame 53 in the first direction (i.e., the −X direction) on one end portion of the second frame 53.

Referring to FIG. 9A, the second frame 53 may include a supporting block 58 formed on one end of the second frame 53.

A supporting rib 83 of the locking member 80 interferes with the supporting block 58 of the second frame 53. Accordingly, the pressing member 57 may maintain a compressed state by the supporting rib 83, and the second supporting surface 54 of the second frame 53 may not be arranged on the second settling groove 62.

That is, as illustrated in FIG. 7A, the projecting part 31 of the toner cartridge 30 may maintain a state of being inserted into the second settling groove 62.

Referring to FIG. 9B, a user may rotate the handle 90 in the +X direction. Accordingly, the contact projection 92 of the handle 90 may move in the +X direction, and the cam surface 92a may contact the sliding surface 82a of the locking member 80, and at the same time, push the sliding surface 82a in the +X direction.

Accordingly, as the handle 90 rotates in the +X direction, the contacting surface between the cam surface 92a and the sliding surface 82a may increase, and the locking member 80 may move in the +Y direction.

Afterwards, according to the movement of the locking member 80, interference between the supporting rib 83 and the supporting block 58 may be released, and by the pressurizing force of the pressing member 57, the second frame 53 may move in the −X direction which is an opposite direction to the rotating direction of the handle 90.

Accordingly, the second supporting surface 54 of the second frame 53 may move to the second settling groove 62, and as illustrated in FIG. 6, the projecting part 31 of the toner cartridge 30 may be released from the state of being inserted into the second settling groove 62. That is, the projecting part 31 of the toner cartridge 30 may be supported by the first settling groove 56 of the second frame 53.

Accordingly, a user can more easily separate the toner cartridge 30 from the holder 60 through rotation of the handle 90, and can more easily replace the toner cartridge 30 by moving the sliding member 50.

In addition, in a case in which the user draws in the sliding member 50 again, the second frame 53 is pressurized by a pressing projection (not shown) that is fixedly arranged on the other end of the second frame 53 that is opposite to one end on which the pressing member 57 is arranged, and the pressing member 57 is compressed again by pressurization.

As the handle 90 rotates and moves in the −X direction again while the pressing member 57 is compressed, the contacting surface between the cam surface 92a and the sliding surface 82a decreases, and the locking member 80 may move in the −Y direction again. Accordingly, the state of the components may automatically return to the state as illustrated in FIG. 9A.

That is, if the sliding member 50 moves from the first location to the second location, the second frame 53 may slide in the first direction (i.e., the Q direction) so that the projecting part 31 of the toner cartridge 30 is inserted into the second settling groove 62. In addition, if the sliding member 50 moves from the second location to the first location, the second frame 53 may move in the second direction (i.e., the P direction) opposite to the first direction (i.e., the Q direction) so that the projecting part 31 of the toner cartridge 30 is supported by the second supporting surface 54.

While examples of the disclosure have been shown and described, the disclosure is not limited to the aforementioned examples, and it is apparent that various modifications can be made by those having ordinary skill in the art to which the disclosure belongs, without departing from the gist of the disclosure as claimed by the appended claims, and such modifications are within the scope of the descriptions of the claims.

What is claimed is:

1. An image forming apparatus comprising:
a main body including a cover;
a location determining member coupled to the main body to settle a toner cartridge in an image forming location;
a sliding member slidably coupled to the main body to move the toner cartridge between a first location outside the main body and a second location inside the main body; and
a holder connected with the cover to move the toner cartridge located in the second location to a third location contacting the location determining member according to a movement of the cover.

2. The image forming apparatus of claim 1, wherein a projecting part formed on both side surfaces of the toner cartridge is moved from a first settling groove formed on the sliding member in the first location to a second settling groove formed on the holder in the second location.

3. The image forming apparatus of claim 2,
wherein the sliding member includes:
a first frame including a first supporting surface movable in a first direction to form one surface of the first settling groove; and
a second frame including a second supporting surface movable in a second direction opposite to the first direction with respect to the first frame to form another surface of the first settling groove, and
wherein the first supporting surface and the second supporting surface are separated in the second location to release the first settling groove.

4. The image forming apparatus of claim 2, wherein a settling location of the projecting part at the second settling groove is the same as or lower than a settling location of the projecting part at the first settling groove.

5. The image forming apparatus of claim 3, wherein the second frame is coupled to the first frame and includes a pressing member to pressurize the second frame in the first direction.

6. The image forming apparatus of claim 5, wherein the sliding member includes:
a handle; and
a locking member between the handle and the second frame to fix the second frame to release the first settling groove and to release the second frame to form the first settling groove.

7. The image forming apparatus of claim 6,
wherein the second frame includes a supporting block formed on one end of the second frame, and
wherein the locking member is selectively engaged with the supporting block according to a movement of the handle.

8. The image forming apparatus of claim 1,
wherein, based on the cover being opened, the holder is located in a fourth location adjacent to the sliding member, and
wherein, based on the cover being closed, the holder is located in a fifth location at which the toner cartridge mounted while being adjacent to the location determining member is located in an image forming location of the location determining member.

9. The image forming apparatus of claim 8,
wherein the holder is connected to the cover through a connecting member,
wherein the holder ascends based on the cover being opened, and
wherein the holder descends based on the cover being closed.

10. The image forming apparatus of claim 9, wherein a moving distance of the holder by the opening or closing of the cover is longer than a moving distance of the toner cartridge by the opening or closing of the cover.

11. The image forming apparatus of claim 9, wherein the connecting member includes a guide projection to be inserted into a guide groove of the holder, which is tilted in an upward direction, and move along the guide groove.

12. The image forming apparatus of claim 1, wherein the holder includes a cam projection to be inserted into a cam groove of the main body, which is formed in a vertical direction, and move along the cam groove.

13. The image forming apparatus of claim 1,
wherein the toner cartridge includes at least one photosensitive drum, and
wherein the at least one photosensitive drum contacts an intermediate transfer belt based on the toner cartridge being located in the third location contacting the location determining member.

14. The image forming apparatus of claim 9,
wherein the cover includes a cover lever hinge-coupled to the cover, and
wherein the connecting member includes an elongated hole coupled to a lower end portion of the cover lever.

15. The image forming apparatus of claim 3, wherein the second supporting surface includes a side surface that is tilted to form the other surface of the first settling groove.
